(19) United States
(12) Patent Application Publication
(10) Pub. No.: US 2010/0153950 A1
(43) Pub. Date: Jun. 17, 2010

(54) POLICY MANAGEMENT TO INITIATE AN AUTOMATED ACTION ON A DESKTOP SOURCE

(75) Inventors: Sivaprasad K GOVINDANKUTTY, Bangalore (IN); Raghavendra Babu B R, Bangalore (IN); Arun Kumar Bhaskar, Bangalore (IN)

Correspondence Address: VMWARE, INC., DARRYL SMITH, 3401 Hillview Ave., PALO ALTO, CA, 94304, US

(73) Assignee: VMware, Inc., Palo Alto, CA (US)

(21) Appl. No.: 12/336,993

(22) Filed: Dec. 17, 2008

(51) Int. Cl. G06F 9/44

(52) U.S. Cl. 718/100

(57) ABSTRACT

A method, apparatus, and system of policy management to initiate an automated action on a desktop source are disclosed. In one embodiment, a machine-readable medium embodying a set of instructions is disclosed. An event is detected. The event associated with a desktop source is automatically determined. A category of the event is determined. A policy is associated to the event based on the category. The policy is applied to the desktop source. Desktop sources may be reshuffled based on the policy. The internal event may be determined as a load balancing issue in which the desktop source may reside in a pool having maximum utilization. The desktop source may be transferred to anther pool having less utilization based on the policy.

### RELATED APPLICATIONS

This application is related to U.S. application Ser. No. ______ (Docket No. A301), entitled “Desktop Source Transfer Between Different Pools” and U.S. application Ser. No. ______ (Docket No. A306), entitled “Network Administration in a Virtual Machine Environment Through a Temporary Pool.”

### FIELD OF TECHNOLOGY

This disclosure relates generally to a method, a technical field of software and/or hardware technology and in one example embodiment, policy management to initiate an automated action on a desktop source.

### BACKGROUND

A desktop source may be a virtual machine, a blade server, or a physical system associated with a user and an operating system. A virtual machine environment may include thousands of desktop sources spread across different pools (e.g., a set of desktop sources in a data center accessed by an end user). An administrator may not discover that something needs to be addressed in the virtual machine environment having many pools because of a sheer number of desktop sources in the virtual machine environment.

Particularly, the administrator may be bandwidth constrained, and it may be inefficient to manually track actions in each of the pools of the virtual machine environment. Therefore, procedures (e.g., rules, regulations, etc.) adopted by an organization may be difficult to implement in practice. Therefore, productivity of the organization may suffer because employees may not be able to access required resources.

### SUMMARY

In one aspect, a machine-readable medium embodying a set of instruction is disclosed. An event is detected. The event associated with a desktop source (e.g., virtual machine, a blade server, a physical system associated with a user and/or an operating system, etc.) is automatically determined. A category of the event is determined. A policy is associated to the event based on the category. The policy is applied to the desktop source. Desktop sources may be reshuffled based on the policy.

In another aspect, a system is disclosed. The system includes a virtual machine server of a data center that hosts a desktop source (e.g., virtual machine, a blade server, a physical system, etc.) associated with different pools. The system includes a connection server to detect an event, to automatically determine that the event is associated with a desktop source, to determine a category of the event, to associate a policy to the event based on the category, and to apply the policy to the desktop source, and to reshuffle the desktop sources based on the policy. The system also includes a set of client devices to access the desktop sources associated with the different pools based on an access privilege specified through the policy.

In yet another aspect, a machine-readable medium embodying a set of instruction is disclosed. An internal event and an external event are identified. A policy from a policy database is associated based on the identification. The policy is applied to a desktop source (e.g., virtual machine, a blade server, a physical system associated with a user and/or an operating system, etc.) based on the policy. The desktop source is reshuffled across a set of pools based on an application of the policy.

### BRIEF DESCRIPTION OF THE DRAWINGS

FIG. 1 is a system view illustrating a policy module communicating an external event and/or an internal event to a connection server, according to one or more embodiments.

FIG. 2 is an exploded view of the policy module illustrated in FIG. 1, according to one or more embodiments.

FIG. 3 is a system view illustrating a policy for an external event, according to one or more embodiments.

FIG. 4 is a system view illustrating a policy for an internal event, according to one or more embodiments.

FIG. 5 is a process flow illustrating transfer of desktop sources between different pools based on a policy, according to one or more embodiments.

### DETAILED DESCRIPTION

In one embodiment, a machine-readable medium embodying a set of instructions that, when executed by a machine, causes the machine to perform a method that includes detecting an event (e.g., an external event and/or an internal event), automatically determining that the event is associated with a desktop source (e.g., virtual machine, a blade server, a physical system associated with a user and/or an operating system, etc.). The machine-readable medium also includes determining a category of the event, associating a policy (e.g., transfer policies, time policy, etc.) to the event based on the category. In addition, the machine-readable medium includes applying the policy to the desktop source and reshuffling a desktop sources based on the policy.

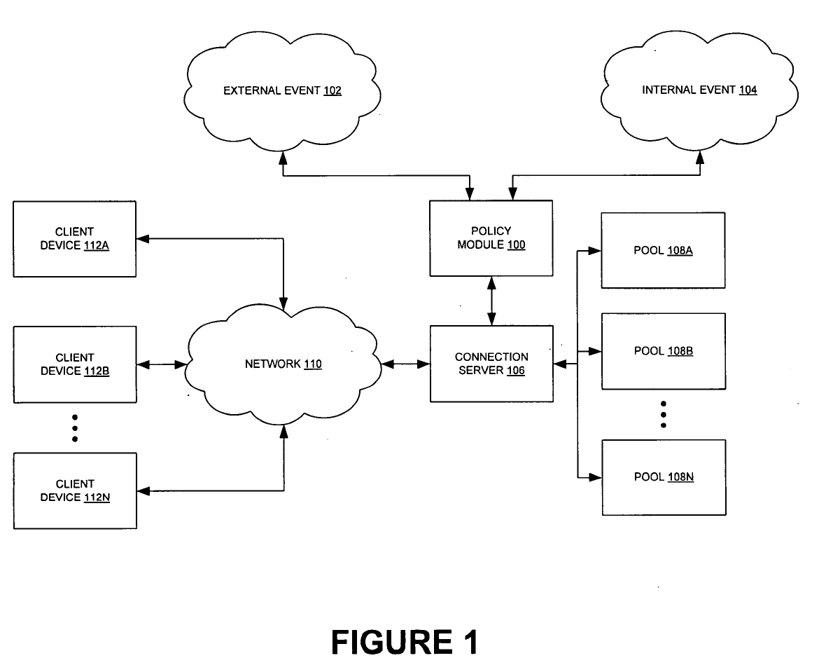

In another embodiment, the system includes a virtual machine server of a data center that hosts a desktop source (e.g., virtual machine, a blade server, a physical system associated with a user and/or an operating system, etc.) associated with different pools (e.g., the pool 108A-N of FIG. 1). The system also includes a connection server (e.g., the connection server 106 of FIG. 1) to detect an event (e.g., an external event and/or an internal event), to automatically determine that the event is associated with a desktop source, to determine a category of the event, to associate a policy (e.g., user defined policies, transfer policies, reshuffle policies, etc.) to the event based on the category, and to apply the policy to the desktop source, and to reshuffle the desktop sources based on the policy. In addition, the system also includes a set of client devices (e.g., the client device 112A-N of FIG. 1) to access the desktop sources associated with the different pools (e.g., the pool 108A-N) based on an access privilege specified through the policy.

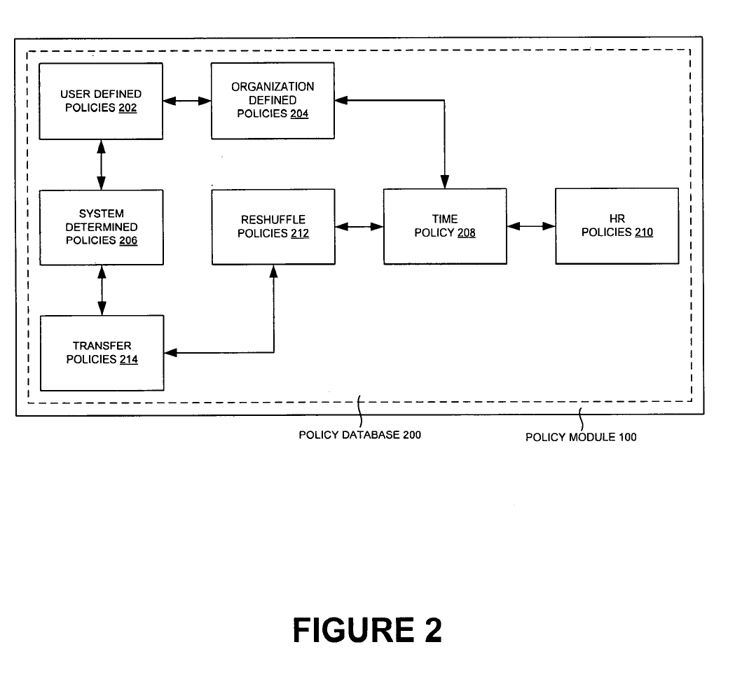

In yet another embodiment, a machine-readable medium embodying a set of instructions that, when executed by a machine, causes the machine to perform a method that includes identifying an internal event (e.g., the internal event 104 of FIG. 1) and an external event (e.g., the external event 102 of FIG. 1). The machine-readable medium includes associating a policy (e.g., organization defined policies, HR policies, etc.) from a policy database (e.g., the policy database 200 of FIG. 2) based on the identification, applying the policy to a desktop source (e.g., virtual machine, a blade server, a physical system, etc.) based on the policy. The machine-readable medium also includes reshuffling the desktop source across a set of pools (e.g., the pool 108A-N of FIG. 1) based on an application of the policy.

FIG. 1 is a system view illustrating a policy module communicating an external event and/or an internal event to a connection server, according to one or more embodiments. Particularly, FIG. 1 illustrates the policy module 100, the external event 102, the internal event 104, the connection server 106, a pool 108A-N, a network 110, and a client device 112A-N, according to one or more embodiments.

The policy module may include the policies that may initiate an action on a desktop source based on a policy. The external event 102 may be an organizational change, addition of employees to an Enterprise resource planning system, etc. The internal event 104 may be a load balancing issue in a pool due to maximum usage of desktop sources in the pool. The connection server may detect an event that may be associated with the desktop source (e.g., a virtual machine, a blade server, etc.) and may apply a policy (e.g., using the policy module 100) to initiate an automated action based on the policy. The pool 108A-N may be a collection of desktop resources (e.g., virtual machine, a blade server, etc.) that may share a common attribute (e.g., a functional role, an operating system etc.). The network 110 (e.g., LAN, WAN, mobile, telecommunications, internet, intranet, WiFi and/or ZigBee network, etc.) may enable communication between the client device 112A-N and the connection server 106. The client device 112A-N may be a personal computer, a laptop, etc that may access the desktop sources associated with the different pools based on the policies.

In an example embodiment, the policy module 100 may communicate with the external event 102, the internal event 104, and/or the connection server 106. The client device 112A-N may communicate to the connection server 106 through the network 110. The connection server 106 may communicate to the pool 108A-N, the policy module 100, and/or the network 110.

In one embodiment, an event (e.g., may be the external event 102 and/or the internal event 104) may be detected. The event that is associated with a desktop source may be automatically determined. A category of the event may be determined. A policy may be associated (e.g., using the policy module 100 of FIG. 1) to the event based on the category. The policy may be applied to the desktop source. The desktop source may be reshuffled based on the policy. The category may be an external event 102 and/or an internal event 104.

The internal event 104 may be determined as a load balancing issue in which the desktop source may reside in a pool having maximum utilization. The desktop source may be transferred to another pool having less utilization based on the policy (e.g., using the policy module 100). The edit command associated with the policy may be processed based on a request of a user. The policy may be modified based on the edit command.

The event may be a limited-use demonstration request, a Software-as a-Service (SaaS) provisioning request, an agent unreachable event, a time based event, a scheduled event, an idle event, and/or a capacity related event. A set of rules of time intervals associated with the scheduled event may be determined. The set of rules may be applied during each of the time intervals when the policy is implemented.

The desktop source may be transferred to a different pool (e.g., the pool 108A-N) after a threshold time interval when the event is the agent unreachable event and the time based event. The source pool may be a group of virtual machines sharing a common attribute. The common attribute may be an organization, a functional role, an application configuration, and/or the operating system.

The virtual machine server of a data center may host desktop sources associated with different pools (e.g., the pool 108A-N). The connection server 106 may detect an event (e.g., may be the external event 102 and/or the internal event 104). The connection server 106 may automatically determine that the event (e.g., the external event 102 and/or the internal event 104) is associated with a desktop source. A category of the event may be determined by the connection server 106. The connection server 106 may associate a policy to the event based on the category, and/or may apply the policy to the desktop source. The connection server 106 may reshuffle the desktop sources based on the policy.

A set of client devices (e.g., the client device 112A-N) may access the desktop sources associated with the different pools (e.g., the pool 108A-N) based on an access privilege specified through the policy. The event may be an external event 102 and/or an internal event 104. An internal event 104 and/or an external event 102 may be identified. The policy may be applied to a desktop source based on the policy. The desktop source may be reshuffled across a set of pools based on an application of the policy.

FIG. 2 is an exploded view of the policy module 100 illustrated in FIG. 1, according to one or more embodiments. Particularly, FIG. 2 illustrates a policy database 200, a user defined policies 202, an organization defined policies 204, a system determined policies 206, a time policy 208, HR policies 210, reshuffle policies 212, and transfer policies 214, according to one embodiment.

The policy database 200 may include policies (e.g., the user defined policies 202, the time policy 208, etc.) that may be used to initiate an action (reshuffle the desktop sources based on the policy, associate a policy based on an event, etc.) on a desktop source. The user defined policies 202 may include a set of policies defined by the user. The organization defined policies 204 may include policies that may be defined based on structure of the organization and/or organizational changes. The system determined policies 206 may include the set of policies that are determined by the system to manage and monitor pools.

The time policy 208 may be applied to a time based event, a scheduled event, and other events that are dependent on time period. The HR (Human resource) policies 210 may include the set of policies that may be used to monitor the desktop sources based on the human resource defined in an organization. The reshuffle policies 212 may include the set of policies that may reshuffle desktop sources associated with the different pools. The transfer policies 214 include the policies that may transfer the desktop sources to different pools based on the category of an event.

In an example embodiment, the policy module 100 may include the policy database 200. The policy database 200 may include the user defined policies 202, the organization defined policies 204, the system determined policies 206, the time policy 208, the HR policies 210, the reshuffle policies 212, and/or the transfer policies. The user defined policies 202 may communicate with organization defined policies 204 and system determined policies 206. The transfer policies 214 may communicate with the system determined policies 206 and the reshuffle policies 212. The time policy 208 may communicate with the reshuffle policies 212, the HR policies 210 and/or the organization defined policies 204.

In one embodiment, a policy from a policy database 200 may be associated based on the identification. The policy database 200 may include user defined policies 202, organization defined policies 204, and/or system determined policies 206. Certain ones of the policies (e.g., the user defined policies 202, the organization defined policies 204, the system determined policies 206, the time policy 208, the HR policies 210, the reshuffle policies 212 and/or transfer policies 214.) may be editable by a user.

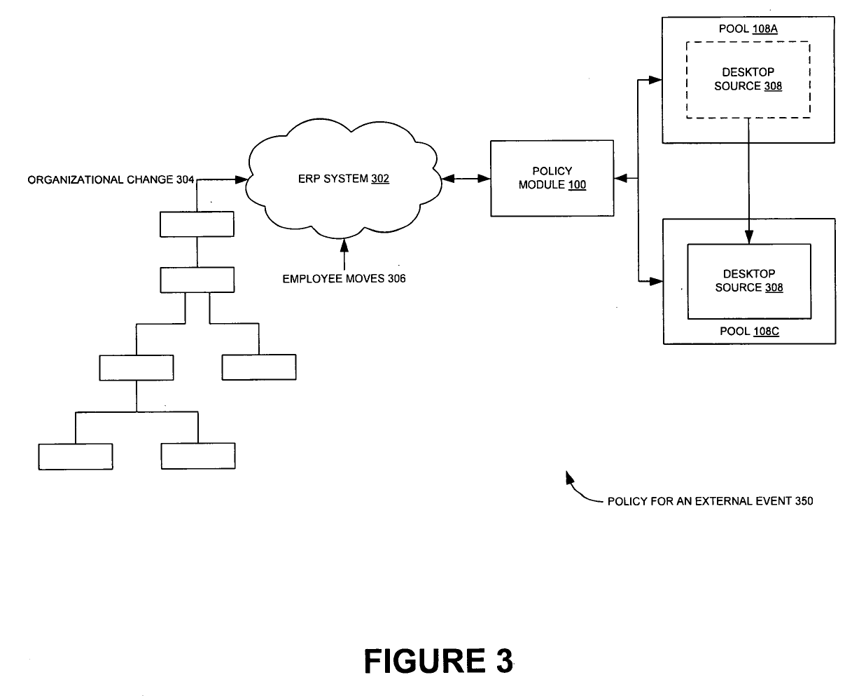

FIG. 3 is a system view illustrating a policy for an external event, according to one or more embodiments. Particularly, FIG. 3 illustrates an ERP system 302, an organizational change 304, an employee moves 306, a desktop source 308, and a policy for an external event 350, according to one embodiments.

The ERP (Enterprise Resource Planning) system 302 may be an enterprise-wide information system designed to coordinate all the resources (e.g., the desktop sources associated with different pools, etc.), information, and activities needed to complete a process. The organizational change 304 may be an external event to the ERP system 302. The organizational change 304 may be a change in the structure of the organization. The employee moves 306 may be an external event that may occur when an employee is moved (e.g., shifted) in the organization. The desktop source 308 may be a virtual machine, a blade server, and/or a physical system associated with a user and an operating system. The policy for an external event 350 may be an illustration of policy management for an external event (e.g., processed through an ERP system 302).

In an example embodiment, the ERP system 302 may have the external events organizational change 304 and/or the employee moves 306. The policy module 100 may communicate with the ERP system 302, the pool 108A and the pool 108C. The desktop source 308 may be moved from the pool 108A to the pool 108C based on a policy.

In one embodiment, the external event 102 may be processed through an Enterprise Resource Planning (ERP) system 302 of an organization. The external event 102 may be determined as an organizational change 304. A desktop source may be reshuffled based on the policy associated with the organizational change 304. The reshuffling may include moving certain ones of the desktop sources between different pools (e.g., the pool 108A-N). Certain ones desktop sources may be transferred in and/out out of respective pools based on the policy (e.g., that may be defined in the policy module 100).

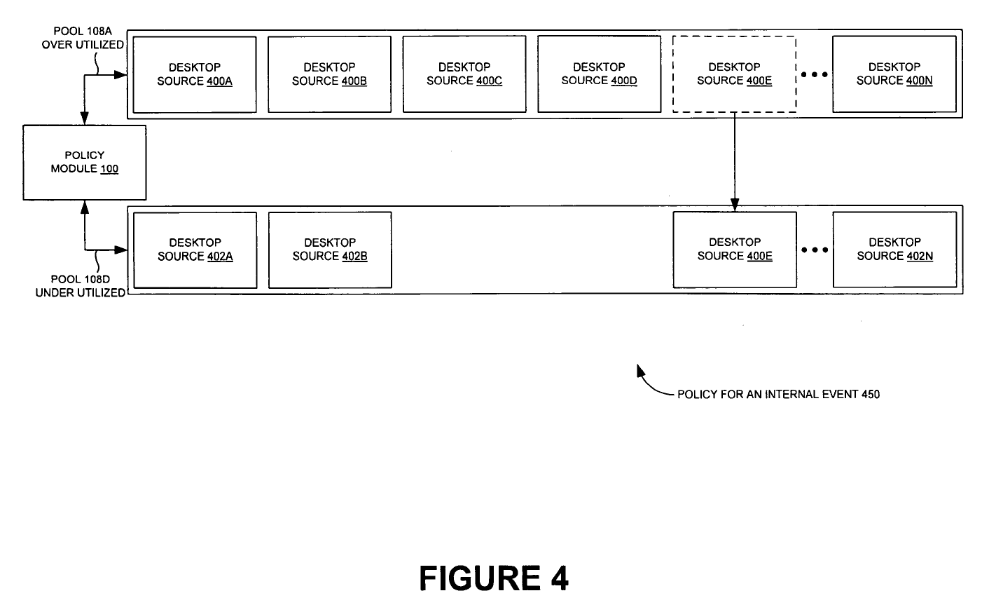

FIG. 4 is a system view illustrating a policy for an internal event, according to one or more embodiments. Particularly, FIG. 4 illustrates the policy module 100, the pool 108A, the pool 108D, a desktop source 400A-N, a desktop source 402A-N, and a policy for internal an internal event 450, according to one embodiment.

The desktop source 400A-N and the desktop source 402A-N may be a virtual machine, a blade server, and/or a physical system associated with a user and an operating system. The policy for an internal event 450 may be an illustration of policy management for an internal event.

In an example embodiment, the policy module 100 may communicate with the pool 108A and the pool 108D. The pool 108A may be over utilized. The pool 108D may be under utilized. The pool 108A may include the desktop source 400A-N. The pool 108D may include the desktop source 402A-N. The desktop source 400E may be transferred from the pool 108A to the pool 108D based on a policy.

In one embodiment, the reshuffling may include moving certain ones of the desktop sources (e.g., the desktop source 400A-N and/or the desktop source 402A-N) between different pools (e.g., the pool 108A and/or the pool 108D) (e.g., certain ones desktop sources may be transferred in and/or out of respective pools based on the policy). The desktop source may be a virtual machine, a physical system, and/or a blade server associated with a user and/or an operating system.

The internal event 104 may be determined as a load balancing issue in which the desktop source may reside in a pool (e.g., the pool 108A) having maximum utilization. The desktop source (e.g., the desktop source 400E) may be transferred to another pool (e.g., the pool 108D) having less utilization based on the policy.

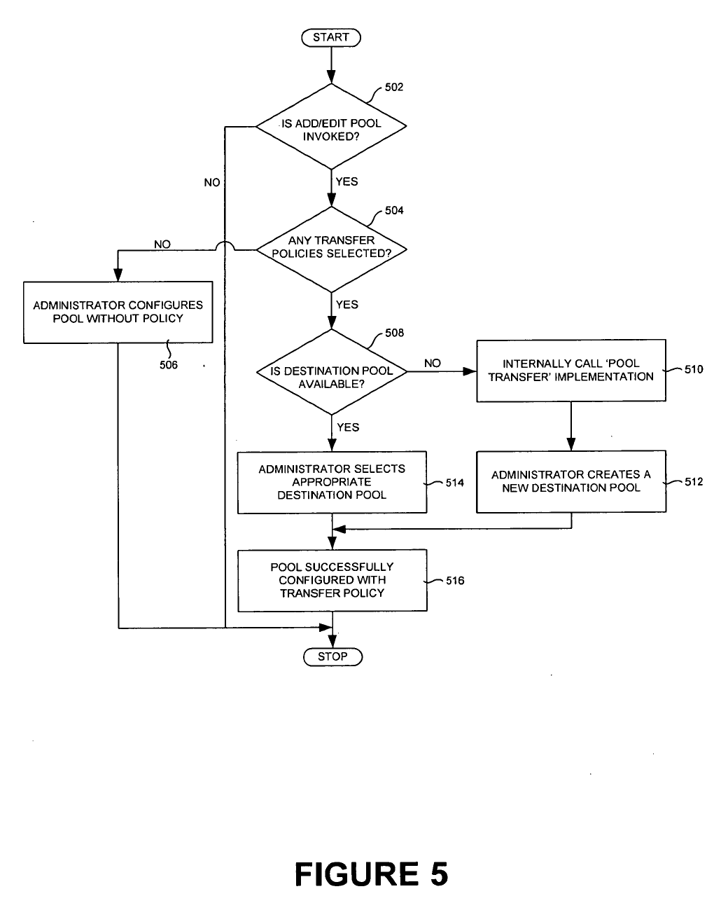

FIG. 5 is a process flow illustrating transfer of desktop sources between different pools based on a policy, according to one or more embodiments. In operation 502, a pool (e.g., the pool 108A-N of FIG. 1) may be invoked due to addition and/or edition of a desktop source. In operation 504, a transfer policy (e.g., the transfer policies 214 of FIG. 2) may be selected. In operation 506, if no policy is selected then the pool may be configured by the administrator. In operation 508, a destination pool for the selected transfer policies may be detected. In operation 510, if the destination pool is not available then pool transfer implementation function may be called internally. In operation 512, the administrator may create a new destination pool. In operation 514, the administrator may select an appropriate destination pool to the selected transfer policies. In operation 516, the pool may be successfully configured with the transfer policy.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the policy module 100, the external event 102, the internal event 104, the connection server 106, the pool 108A-N, the network 110, and the client device 112A-N of FIG. 1, the user defined policies 202, the organization defined policies 204, the system determined policies 206, the time policy 208, the HR policies 210, the reshuffle policies 212, and the transfer policies 214 of FIG. 2, the ERP system 302, the organizational change 304, and the employee moves 306 of FIG. 3, the desktop source 400A-N and the desktop source 402A-N of FIG. 4 may be enabled using a policy circuit, an external event circuit, an internal event circuit, a connection server circuit, a pool circuit, a network circuit, and a client device circuit, a user defined policies circuit, an organization defined policies circuit, a system determined policies circuit, a time policy circuit, a HR policies circuit, a reshuffle policies circuit, and a transfer policies circuit, a ERP system circuit, an organization change circuit, an employee moves circuit, a desktop source circuit and other circuits.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A machine-readable medium embodying a set of instructions that, when executed by a machine, causes the machine to perform a method comprising:
detecting an event;
automatically determining that the event is associated with a desktop source;
determining a category of the event;
associating a policy to the event based on the category;
applying the policy to the desktop source; and
reshuffling a plurality of desktop sources based on the policy.

2. The machine-readable medium of claim 1 wherein the category is at least one of an external event and an internal event.

3. The machine-readable medium of claim 2 further comprising:
determining that the internal event is a load balancing issue in which the desktop source resides in a pool having maximum utilization; and
transferring the desktop source to another pool having less utilization based on the policy.

4. The machine-readable medium of claim 2 wherein the external event is processed through an Enterprise Resource Planning (ERP) system of an organization.

5. The machine-readable medium of claim 4 further comprising:
determining that the external event is an organizational change; and
reshuffling a plurality of desktop sources based on the policy associated with the organizational change.

6. The machine-readable medium of claim 1 further comprising:
processing an edit command associated with the policy based on a request of a user; and
modifying the policy based on the edit command.

7. The machine-readable medium of claim 1 wherein the event is at least one of a limited-use demonstration request, a Software-as a-Service (SaaS) provisioning request, an agent unreachable event, a time based event, a scheduled event, an idle event, and a capacity related event.

8. The machine-readable medium of claim 7 further comprising:
determining a set of rules of time intervals associated with the scheduled event; and
applying the set of rules during each of the time intervals when the policy is implemented.

9. The machine-readable medium of claim 7 further comprising transferring the desktop source to a different pool after a threshold time interval when the event is at least one of the agent unreachable event and the time based event.

10. The machine-readable medium of claim 1 wherein the reshuffling comprises moving certain ones of the desktop sources between different pools such the certain ones desktop sources are transferred in and out of respective pools based on the policy.

11. The machine-readable medium of claim 10:
wherein the source pool is a grouping of virtual machines sharing a common attribute,
wherein the desktop source is at least one of a virtual machine, a physical system, and a blade server associated with a user and an operating system, and
wherein the common attribute is at least one of an organization, a functional role, an application configuration, and the operating system.

12. A system, comprising:
a virtual machine server of a data center that hosts a plurality of desktop sources associated with different pools;
a connection server to detect an event, to automatically determine that the event is associated with a desktop source, to determine a category of the event, to associate a policy to the event based on the category, and to apply the policy to the desktop source, and to reshuffle the plurality of desktop sources based on the policy; and
a set of client devices to access the plurality of desktop sources associated with the different pools based on an access privilege specified through the policy.

13. The system of claim 12 wherein the event is at least one of an external event and an internal event.

14. The system of claim 13:
wherein a determination is made that the internal event is a load balancing issue in which the desktop source resides in a pool having maximum utilization, and
wherein the desktop pool is transferred to another pool having less utilization based on the policy.

15. The system of claim 13:
wherein the external event is processed through an Enterprise Resource Planning (ERP) system of an organization,
wherein the external event is an organizational change, and
wherein a plurality of desktop sources are reshuffled based on the policy associated with the organizational change.

16. The system of claim 12 further comprising: wherein the reshuffling comprises moving certain ones of the desktop sources between different pools such the certain ones desktop sources are transferred in and out of respective pools based on the policy.

17. A machine-readable medium embodying a set of instructions that, when executed by a machine, causes the machine to perform a method comprising:
identifying at least one of an internal event and an external event;
associating a policy from a policy database based on the identification;
applying the policy to a desktop source based on the policy; and
reshuffling the desktop source across a set of pools based on an application of the policy.

18. The machine-readable medium of claim 17 further comprising:
determining that the internal event is a load balancing issue in which the desktop source resides in a pool having maximum utilization; and
transferring the desktop pool to another pool having less utilization based on the policy.

19. The machine-readable medium of claim 18 further comprising:
determining that the external event is an organizational change; and
reshuffling a plurality of desktop sources based on the policy associated with the organizational change, wherein the external event is processed through an Enterprise Resource Planning (ERP) system of an organization.

20. The machine-readable medium of claim 19:
wherein the policy database includes user defined policies, organization defined policies, and system determined policies, and
wherein certain ones of the policies are editable by a user.
